(19) United States
(12) Patent Application Publication
(10) Pub. No.: US 2020/0356956 A1
(43) Pub. Date: Nov. 12, 2020

(54) Mobile Picture Device & Scheduler and Methods of Use

(71) Applicant: Gregory Hampton, JR., North Little Rock, AR (US)

(72) Inventor: Gregory Hampton, JR., north Little Rock, AR (US)

(21) Appl. No.: 16/829,198

(22) Filed: Mar. 25, 2020

Related U.S. Application Data
(60) Provisional application No. 62/844,698, filed on May 7, 2019.

(51) Int. Cl. G06Q 10/10; H04L 29/08; G06T 1/00; H04N 7/04; G06Q 50/18; G06Q 20/08; G06F 21/16

(52) U.S. Cl. CPC G06Q 10/1097; H04L 67/12; G06T 1/0021; G06F 2221/0733; G06Q 50/18; G06Q 20/085; G06F 21/16; H04N 7/04

(57) ABSTRACT

A system for selecting and scheduling digital image capture, including a server for data and communications, a first smart communications device having photography capability in communication with said server, a second smart communications device in communication with said server, said server having a selecting and scheduling digital photography application to communicate with said first smart communications device and said second smart communications device, said selecting and scheduling digital photography application having a function to enable finding, selecting, scheduling, agreeing, capturing, transmitting, the digital image, and thus, tor reviewing & selecting hardware/personnel, scheduling photography, contracting for photography services, payment, capturing photos, and distribution of photos between parties under transaction terms of photography session service via the internet.

### PURPOSE

To improve, simplify, and facilitate scheduling photography, contracting for services, payment, and distribution of photos between parties.

### DETAILED DESCRIPTION AND EXEMPLARY SYSTEM ARCHITECTURE

In describing the exemplary embodiments of the present disclosure, as illustrated in FIGS. 1-2, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

As will be appreciated by one of skill in the art, the present disclosure may be embodied as a method, data processing system, or compute: program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object oriented programming languages, and other conventional programming language may be utilized without departing from the spirit and intent of the present disclosure.

Referring now to FIG. 1, there is illustrated a block diagram of a computing system 10, such as mobile photography device or phone that provides a suitable environment for implementing embodiments of the present disclosure. The computer architecture shown in FIG. 1 is divided into two parts—motherboard 100 and the input/output (I/O) devices 200. Motherboard 100 preferably includes subsystems and/or processors) to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106. or operably disposed in RAM 104. Computing system 10 further preferably includes I/O devices 202, such as main storage device 214 for storing operating system 204 and instructions or application program(s) 206. and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors, with accompanying digital signal processors), one or more processors) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software methods, or by a combination thereof, processor 102 may comprise an entity capable of performing operations according to embodiments of the present invention while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or like hardware, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static aid/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214. such as hard drive, and/or modem each connected via an I/O adapter. Also, although preferred, it is not necessary for all of the devices shown in FIG. 1 to be present to practice the present disclosure, as discussed below. Moreover, devices shown in FIG. 1 may include personal digital devices, smart phones, tablets, personal computers or like devices developed in the future. Furthermore, the devices and subsystems may be interconnected in different configurations from that shown in FIG. 1, or may be based on optical or gate arrays, or some combination of these elements that is capable of responding to and executing instructions or operations. The operation of a computer system such as that shown in FIG. 1 is readily known in the art and is not discussed in further detail in this application, so as not to overcomplicate the present discussion.

In some embodiments, some or all of the functionality facilitating cross-border payments and/or transactions may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processes of the Mobile Picture Device & Scheduler implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

Referring now to FIG. 2, there is illustrated a diagram depicting an exemplary Mobile Picture Device & Scheduler network system in which concepts consistent with the present disclosure may be implemented. Examples of each element within the Mobile Picture Device & Scheduler network system of FIG. 2 are broadly described above with respect to FIG. 1. In particular, the server system 260 and user system 220 have attributes similar to computer system 10 of FIG. 1 and illustrate one possible implementation of computer system 10. Mobile Picture Device & Scheduler network system preferably includes one or more user systems 220, 222, 224, one or more server system 260, and network 250, which could be, for example, the Internet, public network, private network or cloud. User systems 220-224 each preferably include a computer-readable medium, such as random access memory, coupled to a processor. The processor, CPU 102, executes program instructions or operations stored in memory. Mobile Picture Device & Scheduler network system typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or applications) 206 (shown in FIG. 1). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations. Moreover, devices shown in FIG. 2 may include communication, processing, and storage means developed in the future.

Mobile Picture Device & Scheduler network system is capable of delivering and exchanging data between user system 220 and a server system 260 through communications link 240 and/or network 250. Through user system 220, users can preferably communicate over network 250 with each other user system 220, 222, 224, and with other systems and devices, such as server system 260, to electronically transmit, store, manipulate, and/or otherwise use data exchanged between the user system and the server system. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, manipulate, and/or otherwise modify data exchanged between the user system and the server system. The communications link 240 may include, for example, a wired, wireless, cable, optical or satellite communication system or other pathway. It is contemplated herein that RAM 104, main storage device 214, and database 270 may be referred to herein as storage device(s) or memory device(s).

Moreover, Mobile Picture Device & Scheduler network system may be utilized to improve, simplify, and facilitate reviewing & selecting hardware/personnel, scheduling photography, contracting for photography services, payment, and distribution of photos between parties.

It is contemplated herein that parties may download Mobile Picture Device & Scheduler App to their user system 220, 222, 224 via Mobile Picture Device & Scheduler network system and communicate and participate in commerce via Mobile Picture Device & Scheduler network system.

### FIGURES

FIG. 1 is a block diagram of a computer system (Mobile Photography Device) of the present disclosure;

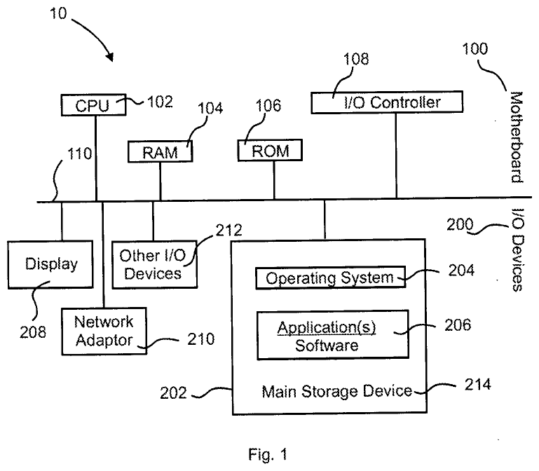

FIG. 2 is a block diagram of a communications system implemented by the computer system in

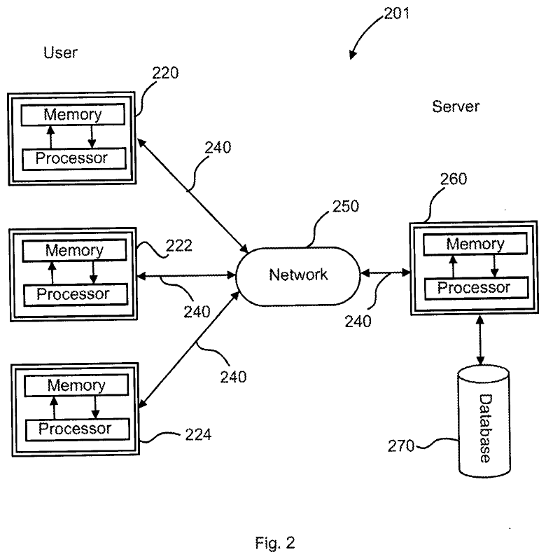

FIG. 3 is a PDF (Hampton_wireframe) block diagram of screen shots, description and flow of a application Mobile Picture Device & Scheduler computer system and methods of use for reviewing & selecting hardware/personnel, scheduling photography, contracting for photography services, payment, and distribution of photos between parties:

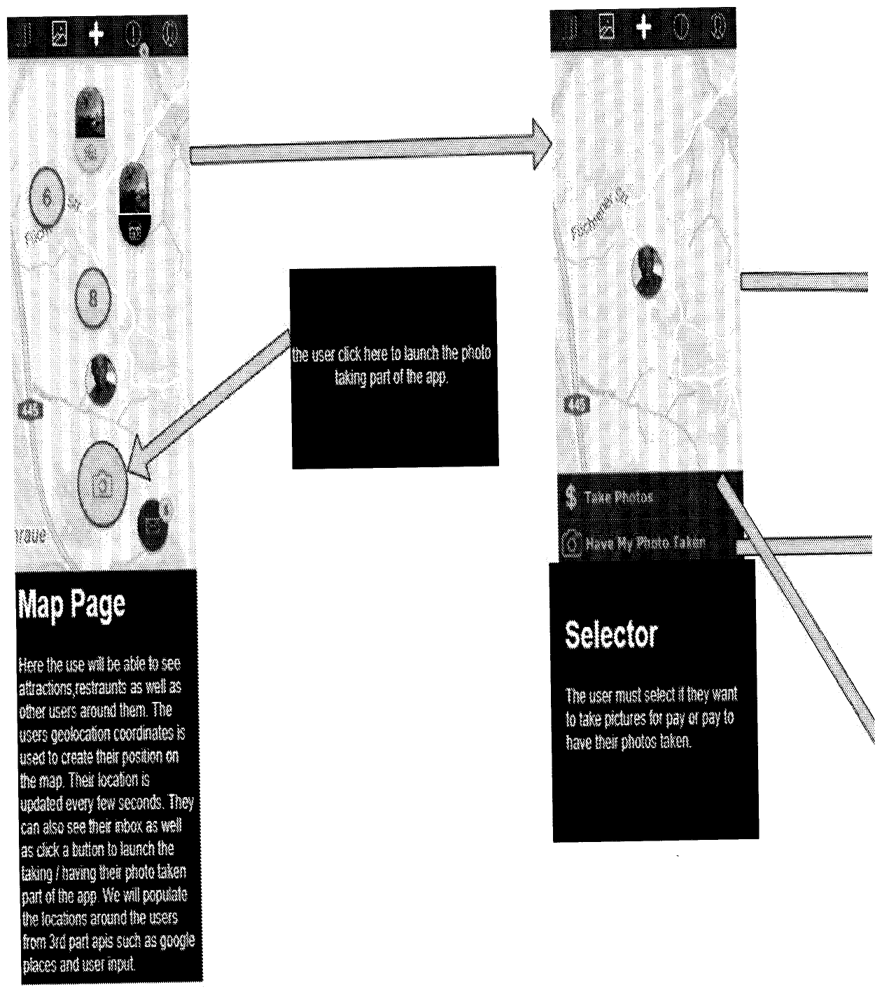

FIG. 4A is a first exploded section view of PDF (Hampton_wireframe) of the FIG. 3 block diagram of screen shots, description and flow of an application Mobile Picture Device & Scheduler computer system and methods of use for reviewing & selecting hardware/personnel scheduling photography, contracting for photography services, payment, and distribution of photos between parties;

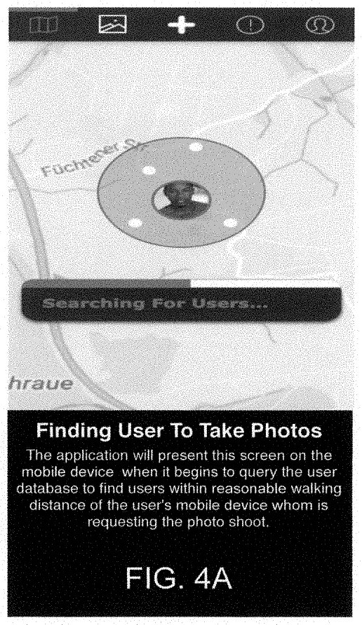

FIG. 4B is a second exploded section view of PDF (Hampton_wireframe) of the FIG. 3 block diagram of screen shots, description and flow of an application Mobile Picture Device & Scheduler computer system and methods of use for reviewing & selecting hardware/personnel, scheduling photography, contracting for photography services, payment, and distribution of photos between parties;

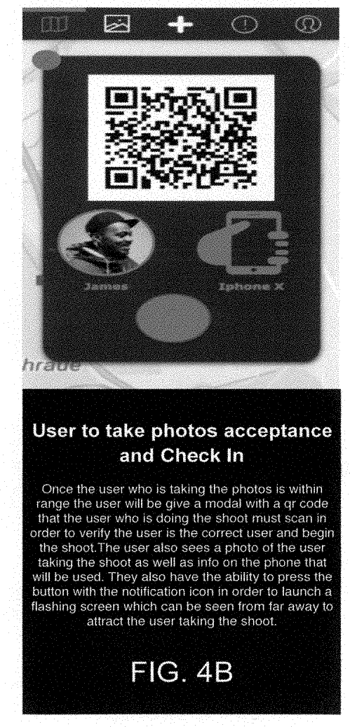

FIG. 4C is a first exploded section view of PDF (Hampton_wireframe) of the FIG. 3 block diagram of screen shots, description and flow of an application Mobile Picture Device & Scheduler computer system and methods of use for reviewing & selecting hardware/personnel, scheduling photography, contracting for photography services, payment, and distribution of photos between parties;

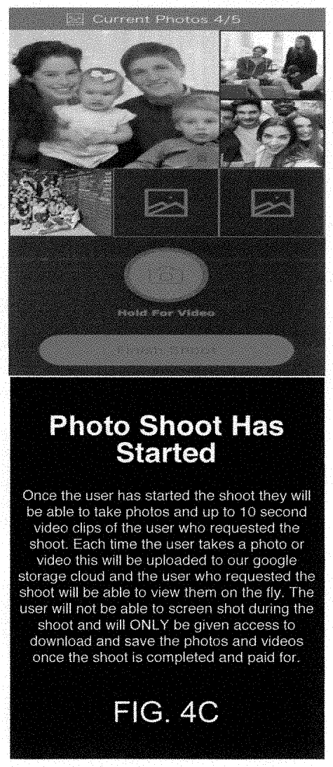

FIG. 4D is a first exploded section view of PDF (Hampton_wireframe) of the FIG. 3 block diagram of screen shots, description and flow of an application Mobile Picture Device & Scheduler computer system and methods of use for reviewing & selecting hardware/personnel, scheduling photography, contracting for photography services, payment, and distribution of photos between parties; and

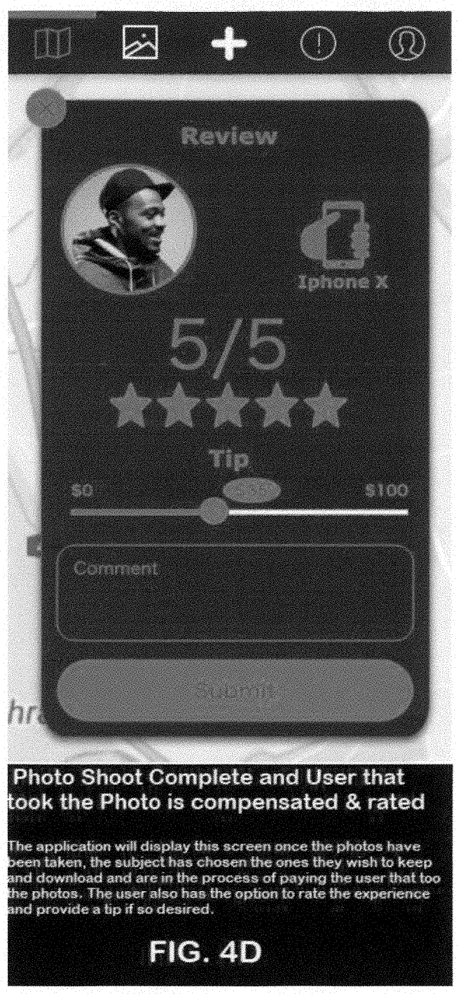

FIG. 5 is a flow chart of a method of use of an application for Mobile Picture Device & Scheduler.

### DESCRIPTION

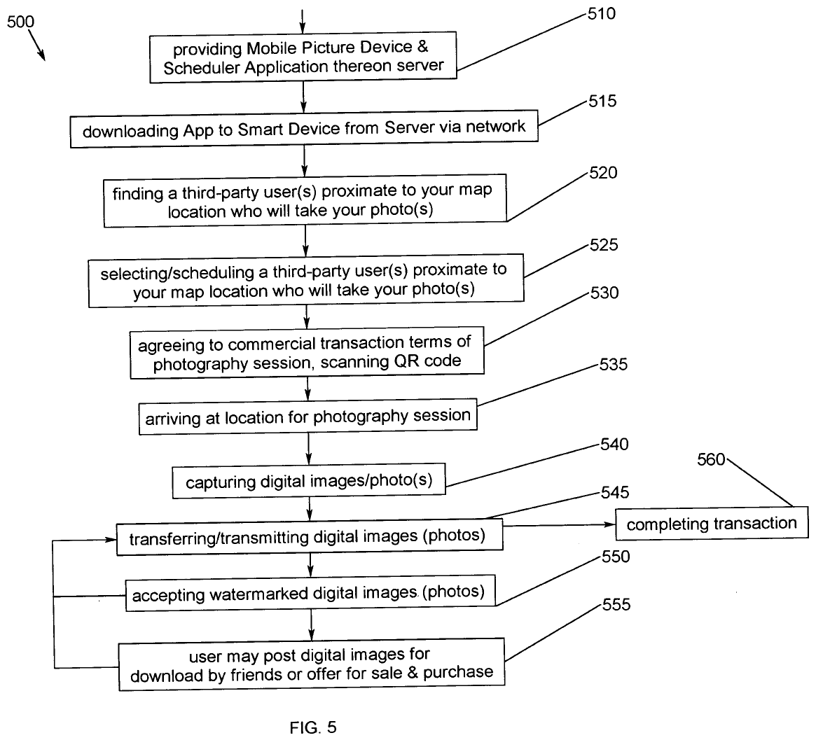

Referring now to FIG. 5, there is illustrated a flow diagram 500 of a method of scheduling photography, contracting for photography services, payment, and distribution of photos between parties on computer system (Mobile Photography Device) via Mobile Picture Device & Scheduler computer system. In block or step 510, providing Mobile Picture Device & Scheduler Application thereon server system 260, such as Mobile Picture Device & Scheduler computer system. In block or step 515, downloading/launching Application to user system 220, 222, 224, such as computer system (Mobile Photography Device) from server system 260 via network 250. In block or step 520, finding a third-party user(s) on user systems 222, 224 proximate to your, user system 220, map location who will take your photo(s) with user system 222, 224. Server system 260 determines and displays third-party user(s) on user systems 222, 224 proximate to your, user system 220 thereon user system 220. In block or step 525, selecting/scheduling a third-party user(s) from user system 222 proximate to your, user system 220, map location and having the desired photographic equipment to take your photo(s) with user system 222. User system 220 transmits a selection user system 222 to server system 260. In block or step 525, agreeing to commercial transaction terms of service, such as photo format, editing, file size, duration, location, ownership, compensation, and the like terms for the photography session. Server system 260 displays third-party user(s) on user systems 222 commercial transaction terms thereon user system 220. In block or step 530, accepting commercial transaction terms of photography session service by user system 222. User system 220 transmits an acceptance of user system 222 to server system 260. In block or step 535, arriving at location for photography session user system 220 and user systems 222, scanning QR code therebetween. User system 220 and user system 222 transmits an arrival of user system 222 to server system 260 or server system 260 determines the same via User system 220 and user system 222 location. In block or step 540, capturing digital images (photos) specified by user system 220 on user system 222. User system 222 captures one or more digital images specified by user system 220 and saves digital images on user system 222. User system 222 may edit digital images. In block or step 545, transferring/transmitting digital images (photos) from user system 222 to server system 260, and transferring watermarked digital images (photos) from server system 260 to user system 222 via network 250. In block or step 550, accepting watermarked digital images (photos) from user system 222 by user system 220. User system 220 transmits an acceptance watermarked digital images (photos) to server system 260. Server system 260 transmits non-watermarked digital images (photos) to user system 222. Server system 260 completing transaction, in block or step 560, based on terms of service between user system 222 and user system 220. Each party, user system 220 and user system 222 may review the other regarding commercial transaction terms of photography session. In block or step 555, displaying non-watermarked digital images (photos) for friends and family user system 224 to download and/or displaying watermarked digital images (photos) for third parties user system 224 to view, purchase, and download. Server system 260 completes transaction based on terms of service between user system 224 and user system 220. Server system 260 transmits non-watermarked digital images (photos) to user system 224.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such dial structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims Accordingly, the present disclosure is not limited to the specific embodiments illustrated herein, but is limited only by the following claims.

What is claimed is:

1. A system for selecting and scheduling digital mage capture, said system comprising:
a server for data and communications;
a first smart communications device having photography capability in communication with said server
a second smart communications device in communication with said server;
said server having a selecting and scheduling digital photography application to communicate with said first smart communications device and said second smart communications device, said selecting and scheduling digital photography application having a function to enable finding, selecting, scheduling, agreeing, capturing, transmitting, the digital image.

2. A computer-implemented method for digital image capture, said method comprisingthie steps of:
providing a server for data and communications, a first smart communications device having photography capability in communication with said server, a second smart communications device in communication with said server, said server having a digital photography application:
finding a user of a second smart communications device proximate first smart communications device:
scheduling said user of a second smart communications device for a photography session;
agreeing to commercial transaction terms of service for said photography session;
accepting commercial transaction terms of photography session.

3. The method of claim 2, further comprising the step of arriving at location for photography session.

4. The method of claim 3, further comprising the step of capturing digital images (photos) specified by user of first smart communications device on said second smart communications device.

5. The method of claim 4, further comprising the step of transferring/transmitting said digital image (photos) from said second smart communications device to said server.

6. The method of claim 5, further comprising the step of transferring/transmitting a watermarked digital image (photos) from said server to a user of said first smart communications device.

8. The method of claim 7, further comprising the step of accepting said watermarked digital images (photos) by a user of said first smart communications device.

9. The method of claim 8, further comprising the step of transferring/transmitting anon-watermarked digital image (photos) from said server to a user of said first smart communications device.

10. The method of claim 8, further comprising the step of completing transaction.

11. The method of claim 8, further comprising the step of displaying non-watermarked or watermarked digital image (photos) for a second smart communications device in communication with said server to download.
